(19) United States
(12) Patent Application Publication
(10) Pub. No.: US 2022/0244055 A1
(43) Pub. Date: Aug. 4, 2022

(54) POST INFORMATION RELIABILITY JUDGMENT DEVICE, POST INFORMATION RELIABILITY JUDGMENT METHOD, AND POST INFORMATION RELIABILITY JUDGMENT PROGRAM

(71) Applicant: NIPPON TELEGRAPH AND TELEPHONE CORPORATION, Tokyo (JP)

(72) Inventors: Chihiro YAMAMOTO, Tokyo (JP); Shunsuke KONAGAI, Tokyo (JP); Hiroshi KONISHI, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/611,484

(22) PCT Filed: May 16, 2019
(86) PCT No.: PCT/JP2019/019582

§ 371 Date: Nov. 15, 2021

(51) Int. Cl. G01C 21/30; G01C 21/34

(52) U.S. Cl. CPC G01C 21/30; G01C 21/3492; G01C 21/3484

(57) ABSTRACT

An input unit receives an input of posted information including information regarding passage of links which connect sites in a geographic network. A posted information credibility determination unit (30) determines credibility of the posted information by comparing movement features obtaining from the posted information with movement features obtained in advance with regard to the links in the geographic network and obtained from movement results during the passage of the links.

### TECHNICAL FIELD

The technology of the present disclosure relates to a posted information credibility determination device, a posted information credibility determination method, and a posted information credibility determination program.

### BACKGROUND ART

In recent years, as the barrier-free movement has been promoted, collection of accessibility information of routes in order to search for appropriate routes for users whose conditions of route accessibility (hereinafter referred to as route conditions), such as the elderly or people in wheelchairs, are different from those of healthy people is being attempted.

For example, a map information survey support device disclosed in Japanese Patent Application Publication No. 2017-102279 supports a map information survey by enabling recording of survey results obtained by surveying natural features and routes on a map while a surveyor is moving, in association with geographic networks.

### SUMMARY OF THE INVENTION

### Technical Problem

An information poster who carries out a survey in map information survey support (hereinafter referred to as a poster) is a volunteer who does not know detailed accessibility information in some cases. Thus, credibility of the posted information posted by the poster is not necessarily high.

Accordingly, to register the posted information as accessibility information used for a user to search for a route or the like, it is necessary to determine credibility of posted information, and then to register information with high credibility (see FIG. 20).

As a method of checking credibility of posted information, there is a method of dispatching a person to a field, but this requires a vast amount of time.

There is also a method of using evaluation information of other posts between users (Koji Yamamoto, Daisuke Katagami, Katsumi Nitta, Akira Aiba, and Hitoshi Kuwata, “The Credibility of Posted Information in a Recommender System Based on a Map”, Journal of Japanese Society for Artificial Intelligence Vol. 21, No. 3, 2006). When credibility is determined using this method, it is necessary to post evaluation on each piece of posted information. However, it is difficult to determine credibility of posted information on which evaluation is not posted.

The technology of the present technology has been devised in view of the foregoing circumstances and an objective of the technology of the present disclosure is to provide a posted information credibility determination device, a posted information credibility determination method, and a posted information credibility determination program capable of determining credibility of posted information easily regarding passage of links in a geographic network.

### Means for Solving the Problem

A first aspect of the present disclosure is a posted information credibility determination device including: an input unit configured to receive an input of posted information including information regarding passage of links which connect sites in a geographic network; and a posted information credibility determination unit configured to determine credibility of the posted information by comparing movement features obtained from the posted information with movement features obtained in advance with regard to the links in the geographic network and obtained from movement results during the passage of the links.

A second aspect of the present disclosure is a posted information credibility determination method including: receiving an input of posted information including information regarding passage of links which connect sites in a geographic network by an input unit; and determining credibility of the posted information by comparing movement features obtained from the posted information with movement features obtained in advance with regard to the links in the geographic network and obtained from movement results during the passage of the links by a posted information credibility determination unit.

A third aspect of the present disclosure is a posted information credibility determination program causing a computer to perform processes of: receiving an input of posted information including information regarding passage of links which connect sites in a geographic network; and determining credibility of the posted information by comparing movement features obtained from the posted information with movement features obtained in advance with regard to the links in the geographic network and obtained from movement results during the passage of the links.

### Effects of the Invention

According to the technology of the present disclosure, it is possible to simply determine credibility of posted information regarding passage of links.

### BRIEF DESCRIPTION OF DRAWINGS

FIG. 1 is a diagram illustrating a method of determining credibility of posted information.

FIG. 2 is a diagram illustrating examples of movability and a movement speed for each route condition.

FIG. 3 is a schematic block diagram illustrating an example of a computer functioning as a posted information credibility determination device according to an embodiment.

FIG. 4 is a block diagram illustrating a configuration of an example of the posted information credibility determination device according to the embodiment.

FIG. 5 is a diagram illustrating an example of a setting screen of a movement means.

FIG. 6 is a diagram illustrating an example of a movement means list.

FIG. 7 is a diagram illustrating an example of a movement result database.

FIG. 8 is a diagram illustrating a result obtained by performing map matching of a movement trajectory to links and nodes in a geographic network.

FIG. 9 is a diagram illustrating an example of an accessibility information database.

FIG. 10 is a diagram illustrating an example of a movement cost database.

FIG. 11 is a diagram illustrating an example of a movement feature database.

FIG. 12 is a diagram illustrating an example of a posted information database.

FIG. 13 is a diagram illustrating an example of posted information associated with links.

FIG. 14 is a diagram illustrating examples of posted information associated with links and a movement result of the links.

FIG. 15 is a diagram illustrating a method of obtaining movability and a movement speed of route information corresponding to posted information.

FIG. 16 is a diagram illustrating a method of calculating credibility in accordance with movability.

FIG. 17 is a diagram illustrating registration of accessibility information based on credible posted information.

FIG. 18 is a flowchart illustrating an example of a movement result collection processing routine in the posted information credibility determination device according to the embodiment.

FIG. 19 is a flowchart illustrating an example of a posted information credibility determination processing routine in the posted information credibility determination device according to the embodiment.

FIG. 20 is a diagram illustrating determination of credibility of posted information to register the posted information as accessibility information used for a user to search for a route or the like.

### DESCRIPTION OF EMBODIMENTS

Hereinafter, an example of an embodiment of the technology of the present disclosure will be described with reference to the drawings. In each drawing, the same reference numerals are given to same or equivalent constituent elements. The dimensions and ratios of the drawings are exaggerated for convenience of description and are different from actual ratios in some cases.

### Overview of Embodiment

According to the embodiment, credibility is determined using a movement result based on a movement trajectory of a user when credibility of posted information which is posted by a map survey support device and includes information regarding passage is determined.

At this time, credibility of posted information is determined by comparing movement features obtained from the movement results based on the movement trajectory of the user with movement features estimated from the posted information.

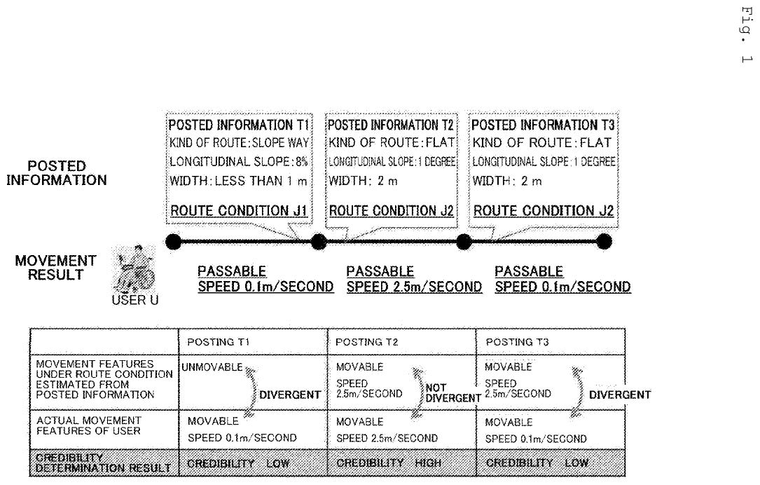

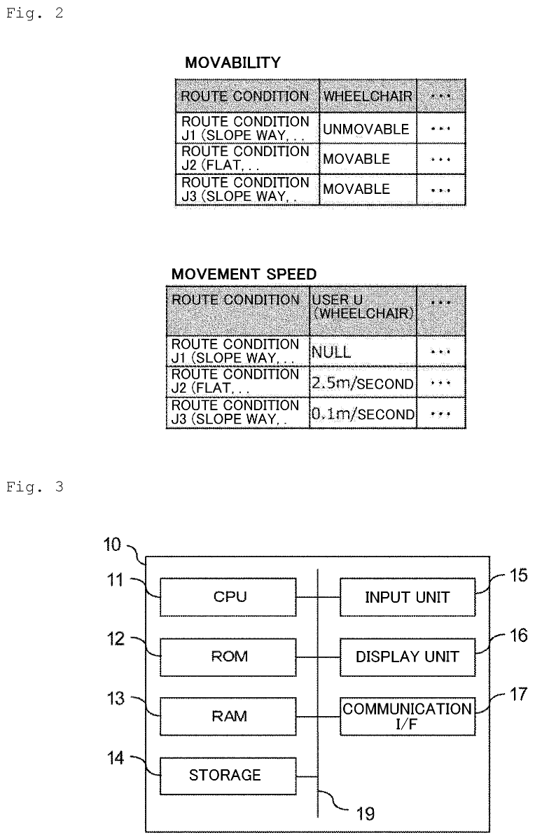

Specifically, as illustrated in FIGS. 1 and 2, credibility of posted information is determined by comparing movement features (movability and a movement speed) of the user during passage under route conditions extracted from posted information regarding a link K with actual movement features (movability and a movement speed) of a user during passage of the link K. Here, the link is a link connecting sites in a geographic network.

Thus, even when an evaluation post of the posted information cannot be obtained, it is possible to determine credibility using the movement result of the user.

Here, the route condition is a specific state of a route and includes all information configured of accessibility information such as a kind of route, a step difference, a longitudinal slope, and a width.

For example, a specific state of a route is expressed as a route condition a and a route condition b as follows:
route condition a: flat, step difference of 2 cm or less, longitudinal slope of 5% or less, and width of 1 m or more, . . . and

route condition b: step, step difference of 16 cm or more, longitudinal slope of 5% or more, and width of 1 m or less . . . .

### Configuration of Posted Information Credibility Determination Device According to Embodiment

FIG. 3 is a block diagram illustrating a hardware configuration of a posted information credibility determination device 10 according to the embodiment.

As illustrated in FIG. 3, the posted information credibility determination device 10 includes a central processing unit (CPU) 11, a read-only memory (ROM) 12, a random access memory (RAM) 13, a storage 14, an input unit 15, a display unit 16, and a communication interface (I/F) 17. These configurations are connected to communicate with each other via a bus 19.

The CPU 11 is a central processing unit and executes various programs or controls each unit. That is, the CPU 11 reads a program from the ROM 12 or the storage 14 and executes the program using the RAM 13 as a working area. The CPU 11 performs controlling each of the configurations and various kinds of arithmetic processing in accordance with programs stored in the ROM 12 or the storage 14. In the embodiment, the ROM 12 or the storage 14 stores a movement result collection program for collecting a movement result and a posted information credibility determination program for determining credibility of input posted information.

The ROM 12 stores various programs and various kinds of data. As a working area, the RAM 13 temporarily stores a program or data. The storage 14 is configured as a hard disk drive (HDD) or a solid-state drive (SSD) and stores various programs including an operating system and various kinds of data.

The input unit 15 includes a pointing device such as a mouse and a keyboard and is used to perform various input operations.

The display unit 16 is, for example, a liquid crystal display and displays various kinds of information. The display unit 16 may function as the input unit 15 by adopting a touch panel system.

The communication interface 17 is an interface for communicating with another device such as a portable terminal carried by a user or a map survey support device carried by a surveyor. For example, a standard such as Ethernet (registered trademark), FDDI, or Wi-Fi (registered trademark) is used.

Inputs according to the embodiment include various kinds of information including positional information obtained through positioning with GPS or the like and transmitted from the portable terminal carried by the user and the posted information transmitted from the map survey support device carried by the surveyor, as illustrated in FIG. 1. The information transmitted from the portable terminal carried by the user includes information indicating that a movement means of the user is one of an autonomous wheelchair, an assistance wheelchair, a user using a baby carriage, a healthy person, and the like.

The posted information includes information for identifying links in a geographic network, and information regarding passage of the links. The information regarding the passage of the links includes accessibility information such as a kind of route, a step difference, a longitudinal slope, and a width.

Next, a functional configuration of the posted information credibility determination device 10 will be described.

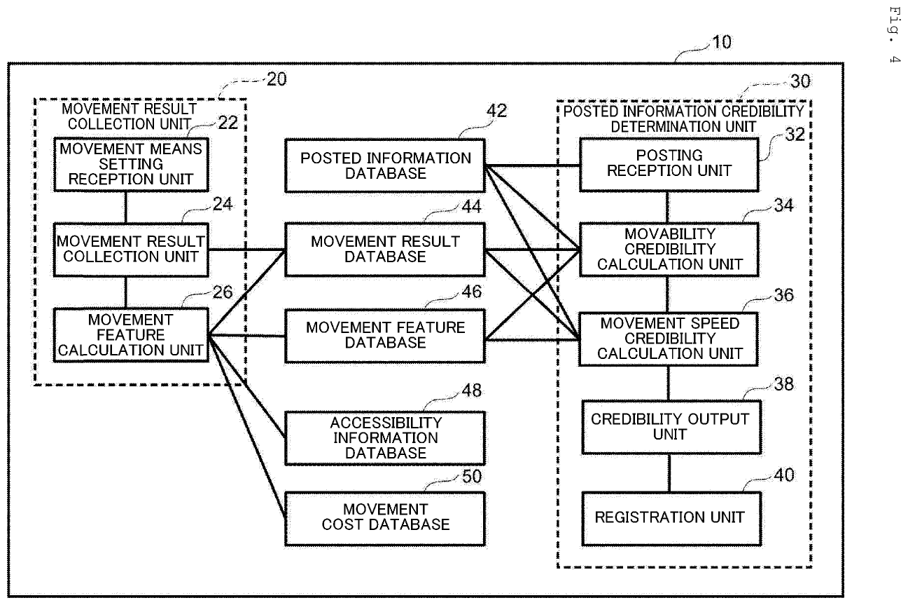

FIG. 4 is a block diagram illustrating an example of a functional configuration of the posted information credibility determination device.

As illustrated in FIG. 4, the posted information credibility determination device 10 includes, as functional configurations, a movement result collection unit 20, a posted information credibility determination unit 30, a posted information database 42, a movement result database 44, a movement feature database 46, an accessibility information database 48, and a movement cost database 50. Each functional configuration is realized by causing the CPU 11 to read the movement result collection program and the posted information credibility determination program stored in the ROM 12 or the storage 14, load the programs on the RAM 13, and executes the programs.

The movement result collection unit 20 collects movement results for each link in the geographic network when each user passes the link and extracts movement features obtained from the movement results collected from the user.

Specifically, the movement result collection unit 20 includes a movement means setting reception unit 22, a movement result collection unit 24, and a movement feature calculation unit 26.

The movement means setting reception unit 22 receives setting of the “movement means” used for the user to move when the movement results are collected.

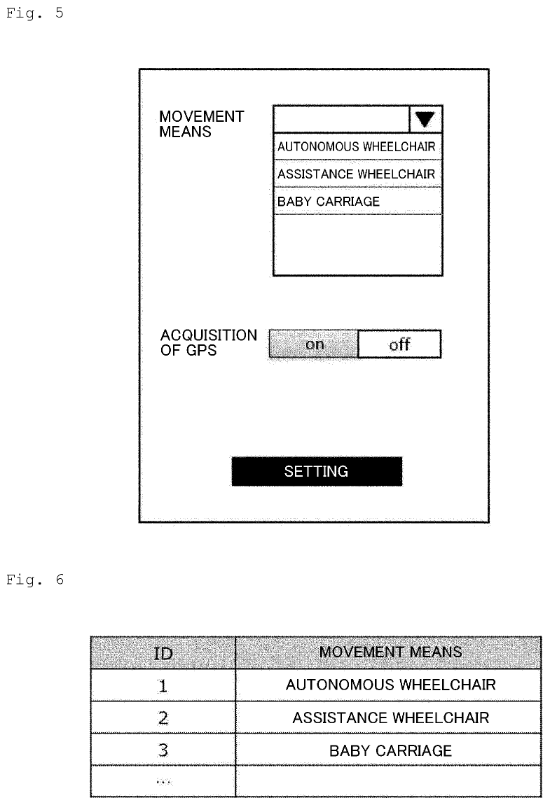

When the movement means is set, the user selects one movement means used to collect movement results from a movement means list on the portable terminal, as illustrated in FIG. 5, and a selection result is transmitted from the portable terminal to the posted information credibility determination device 10. As the movement means list, a list illustrated in FIG. 6 is maintained in the posted information credibility determination device 10. The user selects one movement means from, for example, an autonomous wheelchair, an assistance wheelchair, a baby carriage user, or a healthy person.

Further, the user performs setting to permit acquisition of positional information of GPS or the like on the portable terminal, so that a movement trajectory formed by positional information while the user is moving can be collected (see FIG. 5).

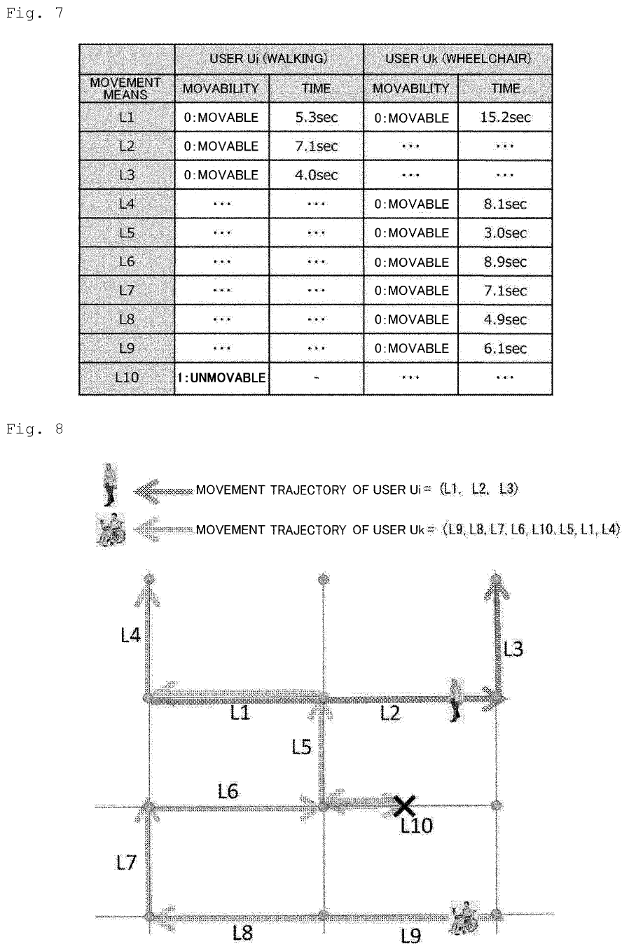

The movement result collection unit 24 obtains a movement trajectory of the user using positional information of GPS or the like and collects movability results of links through which the user passes from the movement trajectory of the user. When the links are movable, the movement result collection unit 24 collects movement times necessary for the passage as movement results and registers the collected movability results and movement results in the movement result database 44 (see FIG. 7).

For example, the movement result collection unit 24 performs map matching of the movement trajectory obtained using the positional information of GPS or the like with the links and nodes in the geographic network, as illustrated in FIG. 8, and extracts movable links, unmovable links, and movement times of the links.

With regard to each link in the geographic network to which accessibility information with high credibility is granted, the movement feature calculation unit 26 extracts a movement speed at which a certain user passes through the link. With regard to each link in the geographic network, the movement feature calculation unit 26 extracts the movement speed as information indicating how much time each movement means takes under a specific route condition, based on the movement speed of each user.

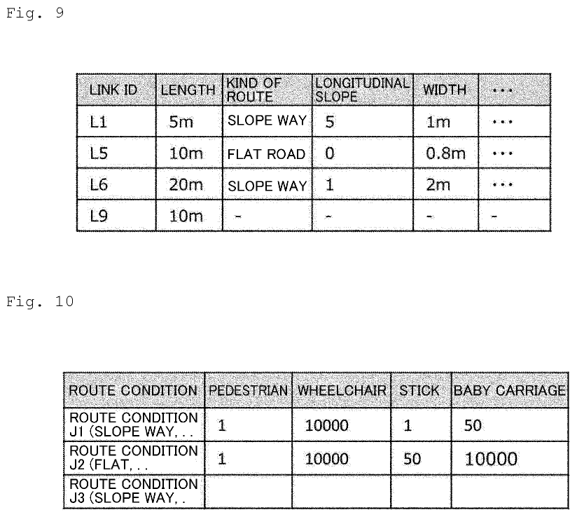

Specifically, the accessibility information with high credibility illustrated in FIG. 9 is first acquired from the accessibility information database 48 and an actual movement time of each user is extracted from the movement result database 44 with regard to the link to which the accessibility information with high credibility is granted.

Then, in the accessibility information of the links included in the accessibility information, route conditions J1, J2, J3, and the like are set in the links because it is considered that there are common route conditions. At this time, each route condition included in the movement cost database 50 which is used in route searching and stores a movement cost granted for each route condition may be used (see FIG. 10). When there is no movement cost database 50, a route condition list may be generated, for example, by manually combining each piece of information included in the accessibility information and setting route conditions J1, J2, J3, and the like.

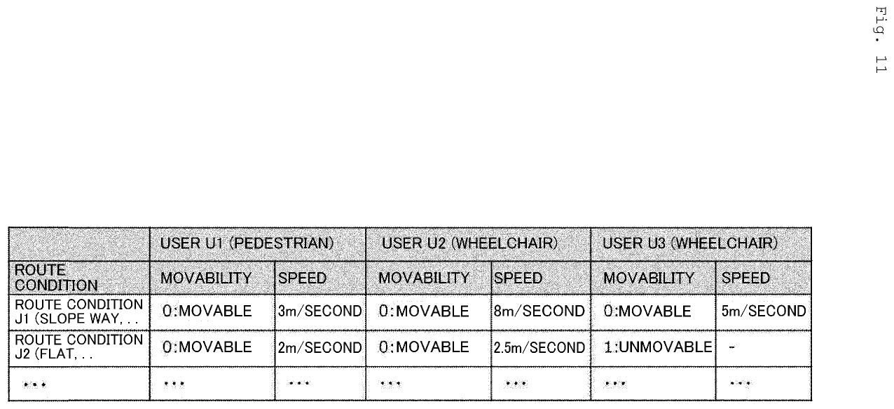

As illustrated in FIG. 11, for each user i, movability in a movement means Ci is obtained for each route condition, an average movement speed during movement of the links by the movement means Ci is calculated from the movement times and the lengths of the links, and the average movement speed is stored in the movement feature database 46.

With regard to the posted information of the received links, the posted information credibility determination unit 30 determines the credibility of the posted information by comparing, for each movement means, the movement features obtained from the movement results during the passage of the links by the movement means with the movement features of the movement means obtained from the posted information.

Specifically, the posted information credibility determination unit 30 includes a posting reception unit 32, a movability credibility calculation unit 34, a movement speed credibility calculation unit 36, a credibility output unit 38, and a registration unit 40.

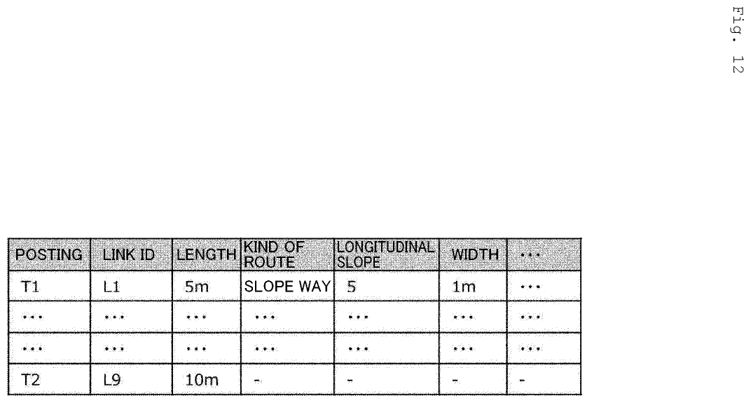

The posting reception unit 32 receives the posted information posted by an information posting means of the map survey support device carried by the surveyor and registers the posted information in the posted information database 42, as illustrated in FIG. 12.

The information posting means of the map survey support device carried by the surveyor posts survey results obtained by surveying natural features and routes on a map while the surveyor is moving in association with the geographic network, as illustrated in FIG. 13. Because the details of the information posting means are similar to a scheme disclosed in Japanese Patent Application Publication No. 2017-102279, description thereof will be omitted.

Next, a principle by which the movability credibility calculation unit 34 calculates credibility will be described.

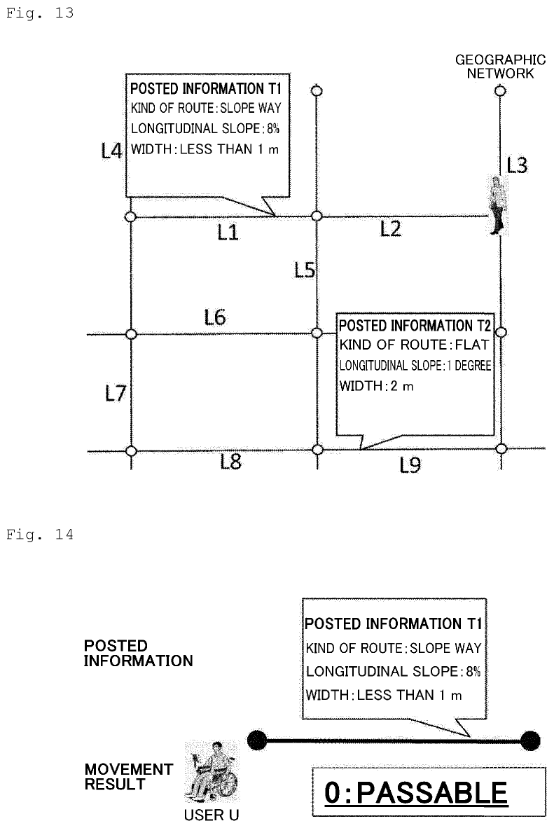

For each movement means, there is a definite impassable route condition. For example, a movement means (wheelchair) cannot pass through a route condition (steps). Information (see FIG. 14) regarding movability in the route condition of each movement means is maintained as “movability information” in the movement result database 44. As illustrated in FIG. 15, the movability information is obtained from the route condition corresponding to the posted information. Then, the credibility of the posted information is determined by comparing the movability information obtained from the route condition corresponding to the posted information with the movability information obtained from the actual movement results.

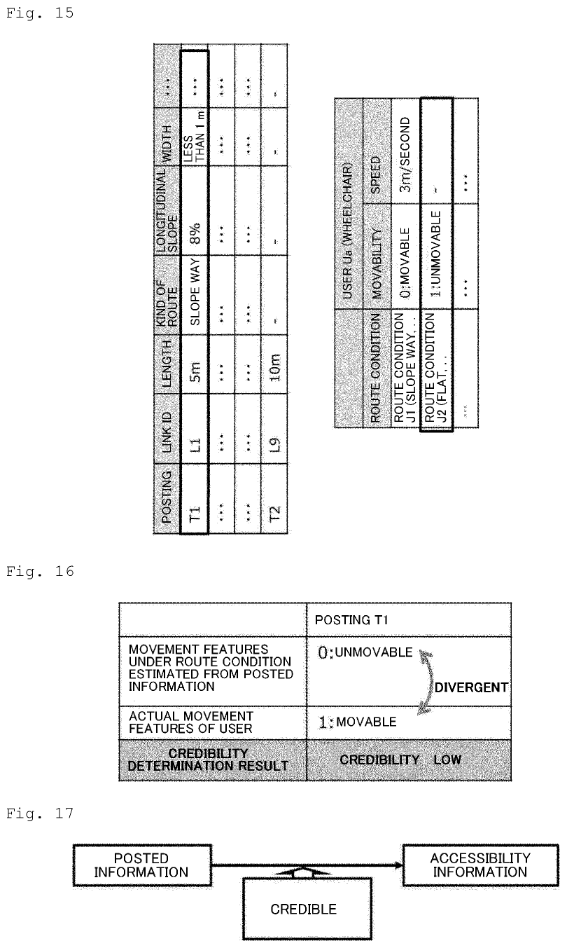

For example, in a case in which a route condition J obtained from the posted information T in a certain link K is immovability of a movement means C from the movability information of the movement feature database 46, the credibility of the posted information T can be understood to be low when there is a movement result by the movement means C in the movement result database 44 (see FIG. 16).

Accordingly, in the embodiment, the movability credibility calculation unit 34 determines credibility using the movability as follows.

First, a movement feature (movability information) Hi under the route condition J of each movement means (i) is extracted from the movement feature database 46 with regard to the route condition J obtained from the posted information T of the link K.

Subsequently, a movement result (movability information) Z1 of each movement means (i) in the link K is extracted from the movement result database 44. When the number of movement results is plural, a movement result (movability information) Zi(m) of each user (m) is extracted.

Then, credibility Q1 is obtained using the following expression, for example.

Credibility Q1=Σ|Hi−Zi(m)|/n

In the foregoing expression, for i=(wheelchair, walking, assistance wheelchair, . . . ) and m=(1, 2, . . . , n), absolute values of differences between the movability information which is movement features and movability information which is movement results are calculated for all the combinations and an average value of the calculated absolute values of the differences is obtained as the credibility Q1.

Next, a principle by which the movement speed credibility calculation unit 36 calculates credibility will be described.

The movement speed credibility calculation unit 36 determines credibility based on a movement speed.

For example, when there are links K1 and K2 and two route conditions are the same, movement speeds of the user U passing the links K1 and K2 are considered to be equal.

Conversely, when the route conditions are different, such as the link K1 which is a flat road and the link 2 which is steps, movement speeds of the user U passing the links K1 and K2 are considered to be different.

Here, a movement speed Y in a case in which the user U is moving under the route condition J obtained from the posted information T in the link K is compared to a movement speed Z obtained from a movement result of an actual movement of the user U in the link K. When there is no divergence between Y and Z, the posted information T is information obtained by correctly surveying a state of the link K and credibility Q2 of the posted information is determined to be high. Conversely, when there is large divergence between Y and Z, the credibility Q2 of the posted information T is determined to be low.

Accordingly, in the embodiment, the movement speed credibility calculation unit 36 determines credibility using a movement speed as follows.

First, the route condition J in the posted information T of the link K is extracted. Subsequently, a user i who has a movement result of the link K is extracted from the movement result database 44. A movement speed Yi under the route condition J of the user i is extracted from the movement feature database 46.

Subsequently, a movement speed Zi of the user i during passage of the link K is obtained from the movement result of the movement result database 44. An average of all differences between the movement speeds Yi and the movement speeds Zi is calculated as the credibility Q2 using the following expression.

Credibility Q2=Σ(Yi−Zi)/n

Here, i=(1, 2, 3, . . . , n) and n is a total number of the movement results of the user in the link K.

The credibility output unit 38 determines credibility using the credibility Q1 in accordance with the movability calculated by the movability credibility calculation unit 34 and the credibility Q2 which is based on the movement speed and is calculated by the movement speed credibility calculation unit 36.

Here, as both the credibility Q1 and the credibility Q2 are low values, the credibility of the posted information T can be said to be high.

Accordingly, in the embodiment, the credibility output unit 38 obtains credibility S using the following expression, for example.

S=a*Q1+b*Q2

Here, a and b are constants.

The credibility output unit 38 determines that the posted information T is credible when the credibility S of the posted information T obtained above is equal to or less than a threshold K, and determines that the posted information T is not incredible when the credibility S is greater than the threshold K, and outputs a determination result.

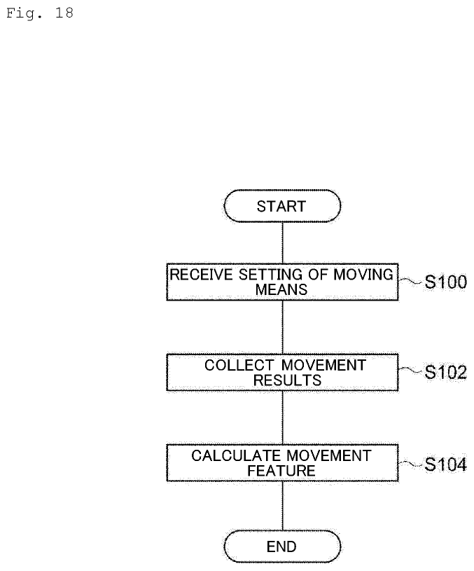

As illustrated in FIG. 17, the registration unit 40 registers accessibility information of the link K based on the posted information T determined to be credible to the credibility output unit 38.

### Operation of Posted Information Credibility Determination Device According to Embodiment

Next, an operation of the posted information credibility determination device 10 will be described.

FIG. 18 is a flowchart illustrating a flow of a movement result collection process performed by the posted information credibility determination device 10. The CPU 11 performs the movement result collection process by reading a movement result collection program from the ROM 12 or the storage 14 and loading and executing the program on the RAM 13.

In step S100, for each user, the CPU 11 serving as the movement means setting reception unit 22 receives setting of a “movement means” during movement of the user.

In step S102, for each user, the CPU 11 serving as the movement result collection unit 24 obtains a movement trajectory of the user using positional information of GPS or the like and collects movability results of the links passed by the user from the movement trajectory of the user. When the links can be moved, the CPU 11 collects movement times necessary for the passage as movement results and registers the collected movability results and movement results in the movement result database 44.

In step S104, for each user, the CPU 11 serving as the movement feature calculation unit 26 extracts the movement speed and the movability information during the passage of the link with regard to each link on the geographic network to which the accessibility information with high credibility is granted. For each user, the CPU 11 serving as the movement feature calculation unit 26 registers the movability information in the movement means of the user in the movement feature database 46 under a specific route condition based on the movability result of each user with regard to each link on the geographic network. For each user, the CPU 11 serving as the movement feature calculation unit 26 extracts the movement speed in the movement means of the user and registers the movement speed in the movement feature database 46 under the specific route condition based on the movement speed of each user with regard to each link on the geographic network.

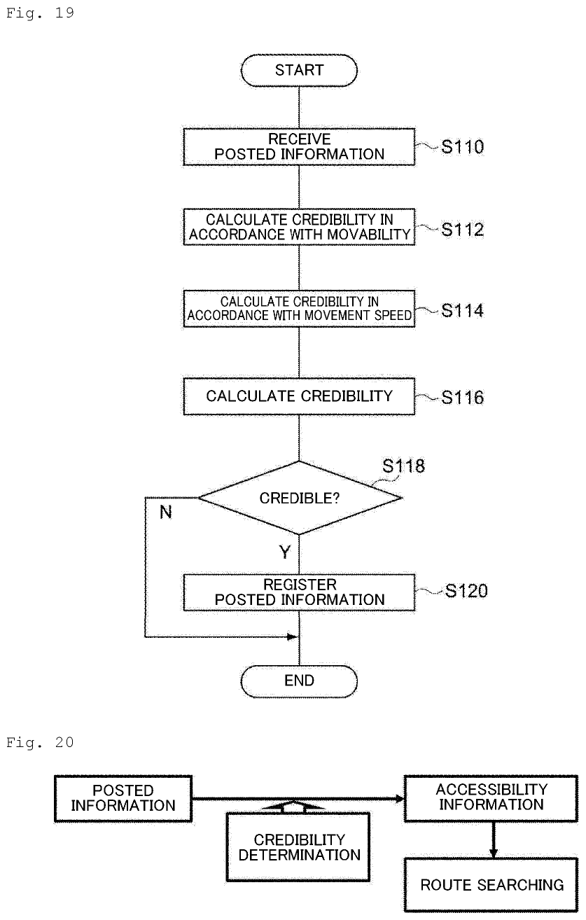

FIG. 19 is a flowchart illustrating a flow of a posted information credibility determination process performed by the posted information credibility determination device 10. The CPU 11 performs the posted information credibility determination process by reading a posted information credibility determination program from the ROM 12 or the storage 14, loading the posted information credibility determination program on the RAM 13, and executing the program.

In step S110, the CPU 11 serving as the posting reception unit 32 receives the posted information T in the link K posted by the information posting means of the map survey support device.

In step S112, the CPU 11 serving as the movability credibility calculation unit 34 calculates the credibility Q1 obtained using the movability based on the movement result of each movement means in the link K obtaining from the movement result database 44 and the movability information under the route condition J of each movement means (i) obtaining from the movement feature database 46 with regard to the route condition J obtained from the posted information T of the link K.

In step S114, the CPU 11 serving as the movement speed credibility calculation unit 36 calculates the credibility Q2 obtained using the movement speed based on the movement speed under the route condition J obtained from the movement feature database 46 for the user i who has the movement result of the link K and the movement speed obtained from the movement result database 44 during the passage of the link K by the user i.

In step S116, the CPU 11 serving as the credibility output unit 38 calculates the credibility S of the posted information T using the credibility Q1 calculated by the movability credibility calculation unit 34 in accordance with the movability and the credibility Q2 calculated by the movement speed credibility calculation unit 36 based on the movement speed.

In step S118, based on calculated the credibility S, the CPU 11 serving as the credibility output unit 38 determines whether the posted information T is credible. When the posted information T is determined not to be credible, the posted information credibility determination process ends. Conversely, when the posted information T is determined to be credible, the process proceeds to step S120.

In step S120, the CPU 11 serving as the registration unit 40 registers the accessibility information of the link K based on the posted information T determined to be credible by the credibility output unit 38 and ends the posted information credibility determination process.

As described above, the posted information credibility determination device 10 according to the embodiment of the technology of the present disclosure receives an input of posted information including information regarding passage of links which connect sites in a geographic network. The posted information credibility determination device 10 determines credibility of the posted information by comparing movement features obtaining from the movement result of the links with movement features obtaining from the posted information. Thus, it is possible to simply determine the credibility of the posted information regarding the passage of the links. In particular, when the credibility of the posted information posted from a surveyor in the map information survey support device is determined and posting of evaluation from a user other than a poster cannot be obtained, the credibility of the posted information can be determined by using the movement result information of another user.

In each embodiment, the movement result collection process and the posted information credibility determination process performed by causing the CPU to read software (a program) may be performed by any of various processors other than the CPU. In this case, examples of the processors include a programmable logic device (PLD) such as a field-programmable gate array (FPGA) capable of changing a circuit configuration after manufacture and a dedicated electric circuit such as an application specific integrated circuit (ASIC) which is a processor with a dedicated circuit configuration designed to perform a specific process. The movement result collection process and the posted information credibility determination process may be performed by one of the various processors or may be performed by the same kind or different kinds of two or more processors in combination (for example, a plurality of FPGAs and a combination of a CPU and an FPGA). More specifically, hardware structures of the various processors are electric circuits in which circuit elements such as semiconductor elements are combined.

In each embodiment, as described above, the movement result collection program and the posted information credibility determination program are stored (installed) in advance in the storage 14, but the present technology is not limited thereto. The program may be provided in a form stored in a non-transitory storage medium such as a compact disk read-only memory (CD-ROM), a digital versatile disk read-only memory (DVD-ROM), a universal serial bus (USB) memory. The program may be a form downloaded from an external device via a network.

The posted information database 42, the movement result database 44, the movement feature database 46, the accessibility information database 48, and the movement cost database 50 are contained in the posted information credibility determination device 10 as an example, as described above, but the present technology is not limited thereto. At least one of the posted information database 42, the movement result database 44, the movement feature database 46, the accessibility information database 48, and the movement cost database 50 may be out of the posted information credibility determination device 10.

The following supplements are disclosed with relation to the foregoing embodiments.

(Supplement 1)

A posted information credibility determination device including a memory and at least one processor connected to the memory, wherein the processor receives an input of posted information including information regarding passage of links which connect sites in a geographic network and determines credibility of the posted information by comparing movement features obtaining from the posted information with movement features obtained in advance with regard with the links on the geographic network and obtained from movement results during the passage of the links.

(Supplement 2)

A non-transitory storage medium storing a program which is able to be executed by a computer so that a posted information credibility determination process is performed, wherein the posted information credibility determination process is a process of receiving an input of posted information including information regarding passage of links which connect sites in a geographic network and determining credibility of the posted information by comparing movement features obtaining from the posted information with movement features obtained in advance with regard with the links on the geographic network and obtained from movement results during the passage of the links.

1. A posted information credibility determination device comprising:
a receiver configured to receive an input of posted information including information regarding passage of links which connect sites in a geographic network; and
a posted information credibility determiner configured to determine credibility of the posted information by comparing movement features obtained from the posted information with movement features obtained in advance with regard to the links in the geographic network and obtained from movement results during the passage of the links.

2. The posted information credibility determination device according to claim 1, wherein the posted information credibility determiner determines the credibility of the posted information by acquiring, from movability determined in advance for each of a plurality of route conditions regarding links, movability under the route conditions corresponding to the posted information as the movement features and comparing the movement features with movability which is movement features obtained from the movement results during the passage of the links.

3. The posted information credibility determination device according to claim 1, wherein the posted information credibility determiner unit determines the credibility of the posted information by acquiring, from a movement speed determined in advance for each of a plurality of route conditions regarding links, movement speeds under the route conditions corresponding to the posted information as the movement features and comparing the movement features with movement speeds which are the movement features obtained from the movement results during the passage of the links.

4. The posted information credibility determination device according to claim 1, wherein the movement features obtained from the movement results are movement features obtained for each mover from the movement results during the passage by the mover, the movement features obtained from the posted information are movement features of the mover and the route conditions corresponding to the posted information among a plurality of route conditions regarding the links for each mover, and for each mover, the posted information credibility determiner determines the credibility of the posted information by comparing the movement features obtained from the movement results during the passage of the links by the mover with the movement features of the mover obtained from the posted information.

5. The posted information credibility determination device according to claim 1, wherein the posted information credibility determiner registers information regarding the passage included in the posted information of which the determined credibility is equal to or greater than a threshold in information regarding the passage of each link in the geographic network.

6. A computer-implemented method for determining posted information credibility, the method comprising:
receiving, by a receiver, an input of posted information including information regarding passage of links which connect sites in a geographic network; and
determining, by a posted information credibility determiner, credibility of the posted information by comparing movement features obtained from the posted information with movement features obtained in advance with regard to the links in the geographic network and obtained from movement results during the passage of the links.

7. A computer-readable non-transitory recording medium storing computer-executable program instructions for determining credibility of posted information, that when executed by a processor causes a computer system to:
receive, by a receiver, an input of posted information including information regarding passage of links which connect sites in a geographic network; and
determine, by a posted information credibility determiner, credibility of the posted information by comparing movement features obtained from the posted information with movement features obtained in advance with regard to the links in the geographic network and obtained from movement results during the passage of the links.

8. The posted information credibility determination device according to claim 2, wherein the posted information credibility determiner determines the credibility of the posted information by acquiring, from a movement speed determined in advance for each of the plurality of route conditions regarding links, movement speeds under the route conditions corresponding to the posted information as the movement features and comparing the movement features with movement speeds which are the movement features obtained from the movement results during the passage of the links.

9. The posted information credibility determination device according to claim 2, wherein the movement features obtained from the movement results are movement features obtained for each mover from the movement results during the passage by the mover, the movement features obtained from the posted information are movement features of the mover and the route conditions corresponding to the posted information among a plurality of route conditions regarding the links for each mover, and for each mover, the posted information credibility determiner determines the credibility of the posted information by comparing the movement features obtained from the movement results during the passage of the links by the mover with the movement features of the mover obtained from the posted information.

10. The computer-implemented method according to claim 6,
wherein the posted information credibility determiner determines the credibility of the posted information by acquiring, from movability determined in advance for each of a plurality of route conditions regarding links, movability under the route conditions corresponding to the posted information as the movement features and comparing the movement features with movability which is movement features obtained from the movement results during the passage of the links.

11. The computer-implemented method according to claim 6,
wherein the posted information credibility determiner determines the credibility of the posted information by acquiring, from a movement speed determined in advance for each of a plurality of route conditions regarding links, movement speeds under the route conditions corresponding to the posted information as the movement features and comparing the movement features with movement speeds which are the movement features obtained from the movement results during the passage of the links.

12. The computer-implemented method according to claim 6,
wherein the movement features obtained from the movement results are movement features obtained for each mover from the movement results during the passage by the mover, the movement features obtained from the posted information are movement features of the mover and the route conditions corresponding to the posted information among a plurality of route conditions regarding the links for each mover, and for each mover, the posted information credibility determiner determines the credibility of the posted information by comparing the movement features obtained from the movement results during the passage of the links by the mover with the movement features of the mover obtained from the posted information.

13. The computer-implemented method according to claim 6,
wherein the posted information credibility determiner registers information regarding the passage included in the posted information of which the determined credibility is equal to or greater than a threshold in information regarding the passage of each link in the geographic network.

14. The computer-readable non-transitory recording medium according to claim 7,
wherein the posted information credibility determiner determines the credibility of the posted information by acquiring, from movability determined in advance for each of a plurality of route conditions regarding links, movability under the route conditions corresponding to the posted information as the movement features and comparing the movement features with movability which is movement features obtained from the movement results during the passage of the links.

15. The computer-readable non-transitory recording medium according to claim 7,
wherein the posted information credibility determiner determines the credibility of the posted information by acquiring, from a movement speed determined in advance for each of the plurality of route conditions regarding links, movement speeds under the route conditions corresponding to the posted information as the movement features and comparing the movement features with movement speeds which are the movement features obtained from the movement results during the passage of the links.

16. The computer-readable non-transitory recording medium according to claim 7,
wherein the movement features obtained from the movement results are movement features obtained for each mover from the movement results during the passage by the mover, the movement features obtained from the posted information are movement features of the mover and the route conditions corresponding to the posted information among a plurality of route conditions regarding the links for each mover, and for each mover, the posted information credibility determiner determines the credibility of the posted information by comparing the movement features obtained from the movement results during the passage of the links by the mover with the movement features of the mover obtained from the posted information.

17. The computer-readable non-transitory recording medium according to claim 7,
wherein the posted information credibility determiner registers information regarding the passage included in the posted information of which the determined credibility is equal to or greater than a threshold in information regarding the passage of each link in the geographic network.

18. The computer-implemented method according to claim 10,
wherein the posted information credibility determiner determines the credibility of the posted information by acquiring, from a movement speed determined in advance for each of the plurality of route conditions regarding links, movement speeds under the route conditions corresponding to the posted information as the movement features and comparing the movement features with movement speeds which are the movement features obtained from the movement results during the passage of the links.

19. The computer-implemented method according to claim 10,
wherein the movement features obtained from the movement results are movement features obtained for each mover from the movement results during the passage by the mover, the movement features obtained from the posted information are movement features of the mover and the route conditions corresponding to the posted information among a plurality of route conditions regarding the links for each mover, and for each mover, the posted information credibility determiner determines the credibility of the posted information by comparing the movement features obtained from the movement results during the passage of the links by the mover with the movement features of the mover obtained from the posted information.

20. The computer-readable non-transitory recording medium according to claim 14,
wherein the posted information credibility determiner determines the credibility of the posted information by acquiring, from a movement speed determined in advance for each of the plurality of route conditions regarding links, movement speeds under the route conditions corresponding to the posted information as the movement features and comparing the movement features with movement speeds which are the movement features obtained from the movement results during the passage of the links.
